(19) United States
(12) Patent Application Publication
(10) Pub. No.: US 2007/0203825 A1
(43) Pub. Date: Aug. 30, 2007

(54) SYSTEMS AND METHODS FOR ENABLING CHARITABLE CONTRIBUTIONS FROM PROPERTY

(76) Inventors: James C. Hanifin, Portola Valley, CA (US); Karen L. Ashworth, Portola Valley, CA (US); Gretchen L. Jahn, Portola Valley, CA (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/904,122

(22) Filed: Oct. 25, 2004

Related U.S. Application Data
(60) Provisional application No. 60/514,219, filed on Oct. 24, 2003.

(51) Int. Cl. G06Q 40/00

(52) U.S. Cl. 705/38

(57) ABSTRACT

Systems and methods that provide new methods of charitable giving that increase the flow of contributions from donors to charities. In this way, the present invention helps many charitable causes that are desperately in need of financial support. Most wealth is in real estate, and the new form of charitable giving in accordance with the present invention allows individuals and companies to donate a donor-selected portion of this illiquid asset. A charitable giving liaison organization, in some cases in partnership with an investment bank or any other third-party investor, provides the service to transform this illiquid real estate donation into a liquid donation for the charities and the donors. The charitable giving liaison organization may be a for-profit organization.

### RELATED APPLICATIONS

The present invention claims the benefit of U.S. Provisional Application Ser. No. 60/514,219 Filed on Oct. 24, 2003 entitled “SYSTEMS AND METHODS FOR ENABLING CHARITABLE CONTRIBUTIONS FROM PROPERTY.”

### FIELD OF THE INVENTION

The present invention relates, in general, to financial methods and instruments, and, more particularly, to software, systems and methods for enabling planned giving to charitable organizations using equity held in property such as real estate.

### RELEVANT BACKGROUND

There are currently more than 1.3 million charitable organizations incorporated in the United States, and the number continues to grow. While donations were $241 billion in 2002, the amount has not grown since 1999. Moreover, the total funds held by charities has diminished due to tighter cash flows and a struggling economy. Charitable organizations are faced with ever-rising costs, uncertainty of government funding, and an increasing demand for services. As a result, these organizations are asking for larger contributions from more donors and there is a continuous need for new ways to promote and accomplish charitable giving that increase the flow of contributions from donors to charities.

More than 80% of the money raised by charities in this country comes from individuals. A great deal of wealth in the United States is in real estate, and other tangible and intangible assets. These assets are illiquid in that it is often difficult to convert the asset into a liquid form that can be gifted to a charity. These assets are typically gifted by wills, trusts, and similar instruments that postpone the gift until the donor's death. Selling the property, for example, is an expensive process due to marketing and legal expenses, and may result in a much smaller gift than intended by the donor. While some organizations accept donations of whole or partial interests in various kinds of properties, these types of donations are difficult to implement and generally illiquid making them more difficult for the charitable organization to put to use. Accordingly, there is a strong need for services that transform these illiquid assets into a liquid donation.

The non-profit industry incurs significant expenses in fundraising. This is particularly true in the case of property-based donations. For example, giving a remainder interest in real property may require property appraisals, market forecasts, actuarial analysis, establishing trusts, and a significant amount of legal work to structure the donation. Even when the donor and donee are willing to undertake these processes, the gift may be unusable to the donee for some time. Accordingly, there is a need for a cost effective form of charitable giving, especially for property-based donations, that can eliminate a large percentage of the cost of fundraising.

Of particular interest are giving techniques that enable a donor to gift a portion of some donor-owned property such that the donor may continue to benefit from the property for some time after the gift. At the same time, donors prefer that gifts result in an appropriate tax benefit. Tax deductions are subject to numerous IRS regulations, and may involve computation of complex actuarial tables based on the life expectancy of the donor. From the charity's perspective, giving techniques that provide an immediate useable benefit and/or a guaranteed funding stream are preferred.

Current giving techniques consist of Charitable Remainder Trust (CRT), Charitable Lead Trust (CLT), Charitable Gift Annuity, Life Estate Agreement, Personal Residence Trust (PRT), Qualified Personal Residence Trust (QPRT), Grantor Retained Income Trust (GRIT), and independent foundations. These products require significant effort on the part of the donor, the charity, and the estate advisor to structure the trust to achieve the charitable wishes of the donor while at the same time providing the appropriate tax affects. Often, complex legal documents are required that increase the effort and expense of the donor and/or charitable organization.

Less complex techniques include a bargain sale and direct planned giving by donors, which may be financed using a home equity loan. These products still have a degree of complexity and often do not satisfy both the charitable wishes and personal wishes of the donor while at the same time providing the appropriate tax benefits. In general, these products are difficult for donors to understand and/or affect the donor's cash flow. Many donors have little understanding of the mechanisms involved. These products often provide little or no immediate cash flow to the charity, and may involve the charity managing an asset to provide cash flow to the donor during their lifetime.

Charities continually look for new ways to make it easier for high net worth individuals to support the causes that they believe in. The rise in popularity of planned giving programs, trusts and bequests show that both charities and donors are quick to adopt new forms of giving as they are made available to the market. However, these techniques only provide charities with cash upon the death of the donor. Many of the larger donations and bequests are actually pledges to be paid over time. As a result, the charity may actually receive little cash for the current operating year, as the pledge may be tied up in stocks, trusts, or other illiquid forms.

Charitable organizations themselves are often ill-suited to implement new fund-raising systems. The expertise of a charitable organization lies in the particular cause or causes that they support, and not in the financial and legal transactions necessary to implement an efficient giving system. Accordingly, there is a need for services that can be provided from outside of the charitable organization to benefit the charitable giving market.

### SUMMARY OF THE INVENTION

Briefly stated, the present invention involves systems and methods that provide new methods of charitable giving that increase the flow of contributions from donors to charities. In this way, the present invention helps many charitable causes that are desperately in need of financial support. Most wealth is in real estate, and the new form of charitable giving in accordance with the present invention allows individuals and companies to donate a donor-selected portion of this illiquid asset. A charitable giving liaison organization provides the service to transform this illiquid property donation into a liquid donation for the charities and the donors. Funding may be provided by the charitable giving liaison organization itself, or using a third party funding source such as an investment bank or any other third-party investor. The charitable giving liaison organization may be a for-profit organization.

The present invention comprises methods that enable a donor to designate a dollar amount of the equity in their property to go to the charity of their choice. The donor completes application paperwork that is similar to mortgage and/or equity financing paperwork so that it can be prepared and processed using available loan processing systems and software. Once the paper work is completed, a funding source, such as an investment bank or other investor, reviews the documents per their investment criteria. Once approved, the funding source provides the cash to the charity, and handles the monthly interest payments from the donor. On sale, refinance, or any form of transfer of the property, the funding source receives their principal. In a particular embodiment, the charitable giving liaison organization receives transaction fees from the charity and the funding source for its role in completing the transaction.

### BRIEF DESCRIPTION OF THE DRAWINGS

FIG. 1 shows an environment in which the present invention is implemented during a formation and funding phase of a donation;

FIG. 2 shows an environment in which the present invention is implemented during an operational phase of the donation;

FIG. 3 shows an alternative embodiment in accordance with the present invention;

FIG. 4 illustrates a first donor profile report summarizing the operation of the present invention with respect to a 55 year old donor;

FIG. 5 illustrates a second donor profile report summarizing the operation of the present invention with respect to a 75 year old donor;

FIG. 6 shows a message sequence diagram of an embodiment of the present invention;

FIG. 7 shows a message sequence diagram of an alternative embodiment of the present invention; and

FIG. 8 illustrates an embodiment of the present invention that enables improved corporate giving.

### DETAILED DESCRIPTION OF THE PREFERRED EMBODIMENTS

The present invention is illustrated and described in terms of a particular charitable giving liaison organization that is a for-profit organization that provides services to a variety of charitable organizations. The invention also involves a new financial product called a “charitable giving loan” that enables a donor who owns property to make a charitable gift using equity in that property. The charitable giving liaison organization may be a corporation, limited liability company, partnership, or other business form that meets the needs of a particular application. The charitable giving liaison organization may fund the charitable giving loan or funding may be provided in conjunction with an investment bank or any other funding source may be provided. For example, commercial banks, mortgage companies, investment trusts, individuals, and other investors and/or funding sources are suitable alternatives. It is contemplated that the charitable giving liaison organization may also be formed as a subdivision or service of an organization such as a bank, investment bank, mortgage company, or other business that acts as a funding source and/or infrastructure and implementation source.

The present invention is applicable to a wide variety of charitable giving including gifts to organizations, foundations and causes supporting aging, animal/wildlife protection, arts, children, civil and human rights, consumer protection, disabilities, education, environmental protection, faith-based services, health, homeless, housing, hunger, jails/prisons, mental health, peace, poverty relief, public safety, military/veterans services, museums, social and economic justice, social services, special activities, historical preservation, women, youth and the like. Essentially, any and all forms of non-profit organizations may benefit from implementation of the present invention.

The present invention is of benefit to charities, individuals and businesses that are searching for a new and efficient method to donate, or receive donations, while minimally impacting current cash flow for the donor. The new form of giving is unique in that a donation can be made this year, the deduction taken this year or carried forward per I.R.S. regulations, and the donor does not need to write a check. The process of the present invention involves donating a portion of the equity in the donor's property, and this donation concurrently becomes a cash donation to the charity or charities of their choice. Funding sources, such as investment banks and/or other third party investors, purchase the paper as secured by the property deed, and provide the cash to complete the transaction and subsequently collect interest. Alternatively, the charitable giving liaison organization may carry/hold the paper.

Most governments offer significant incentives in the form of tax benefits to encourage charitable giving. From the donor's viewpoint a successful charitable giving system should allow the donor to take advantage of these incentives as quickly as possible after the donation. From the charitable organization's viewpoint the donation is preferably in a usable form that will take little effort to apply to the organization's purpose. In most cases, the preferable form of a donation is cash. Both donors and charitable organizations desire giving systems that are efficient so that as much of the donation as possible is made available to the charity.

Although charitable contributions come from a variety of sources, the present invention may be particularly useful in the case of four particular sources: individual donors, businesses, foundations and bequests. Today the bulk of donations come from individuals, totaling $184 billion in 2002. The particular implementations of the present invention target donors in the top 5% of U.S. households, or 4.5 million households, with assets in excess of $2 M. The majority of these individuals are over the age of 60 and are more concerned with personal legacy and wealth distribution rather than with young families and wealth accumulation. Research has indicated that more than half of the individuals in this target market feel that it is important to give to charities in their lifetime. This invention, however, is not limited to these particular sources and may be applied to anyone.

In most cases, a majority of the assets of high net worth individuals and/or potential donors are in real estate, and the present invention allows donors a logical option for donations using these assets. The value of real estate historically continues to appreciate. Planned giving experts report that gifts of appreciated real estate have grown in favor as the stock market has declined. The present invention provides means to access this untapped asset class to provide donations that are liquid and deductible while the owner retains ownership and use of the property. In addition, the present invention provides a cost effective form of charitable giving that can reduce or eliminate a large percentage of the cost of fundraising.

Businesses and companies, including corporations, limited liability companies, partnerships, sole proprietorships, and similar legal entities, are a second major target market, with $12 billion in donations in 2002. Corporate gifts to foundations alone were $3.4 billion in 2002. Most gifts are in the form of stock, which has declined in value with the stock market. The present invention offers an attractive alternative for corporations to donate a percentage of the equity in their property holdings, reduce their taxable assets on the books and take a full deduction of the value donated without essentially affecting their cash flow.

Foundations received $22 billion in gifts in 2002, and donated to other charities $27 billion of their assets. In particular, the $6 billion market of community and operating foundations can also make use of the present invention.

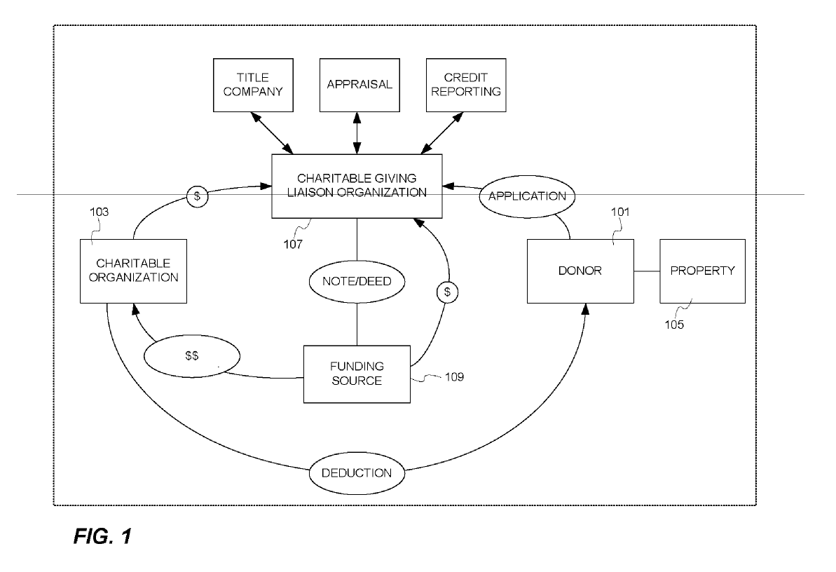

Referring to FIG. 1, the system in accordance with the present invention includes a plurality of entities that provide a conduit between a donor 101 and one or more charitable organizations 103. Each of the entities shown in FIG. 1 perform specific functions and activities in support of this conduit. The entities shown in FIG. 1 are a particular example that may be modified to meet the needs of a particular application. Functions attributed or assigned to a particular entity in this description may be provided by another entity.

A charitable giving loan in accordance with the present invention involves a promise made by the donor 101 to pay money to funding source 109. This promise is documented, for example, by a promissory note. In exchange for this promise, funding source 109 provides funds that are donated to charitable organization 103. The promissory note is typically a negotiable instrument that may be sold or otherwise transferred by the holder. The promissory note may be a “straight note”, also called a “term note”, or may be an amortized note that provides for installment payments at stated intervals. In the case of amortized notes the invention contemplates fully amortized, partially amortized, as well as negatively amortized (i.e., interest accruing) notes to meet the needs of a specific donor's situation. The present invention also contemplates notes that will require payment of principal upon transfer or refinancing of the property, or which may allow the obligation to repay to be transferred or assumed by another party. In addition to a promissory note, the charitable giving loan may be secured by a pledge of the property (i.e., hypothecation). The charitable giving loan is secured, for example, by a mortgage, deed of trust, land contract, or other instrument that serves to evidence the hypothecation of the donor's property.

Donor 101 is an owner of some property 105, which may be real estate, stocks, bonds, a trust, a business, or other type of property that may serve as collateral. Typically the donor owns all or a significant part of property 105 outright, for example at least 40% ownership. Hence, property 105 may be subject to a mortgage or other loan. Property 105 may be residential or commercial property, and may include primary residence of donor 101, a vacation home, raw land, and the like.

A donor 101 that has an interest in making a gift to charitable organization 103 often approaches the organization 103 directly. Charitable organization 103 refers the donor to charitable giving liaison organization 107. Alternatively, donor 101 may approach charitable giving liaison organization 107, or may be solicited by a third party fund raiser, an estate planning attorney, financial planner, accountant, or the like to approach charitable giving liaison organization 107.

Charitable giving liaison organization 107 solicits and/or collects application information from donor 101 and may provide assistance in completing application materials. The present invention contemplates an application process that closely resembles that used in the mortgage and other collateralized loan industries. Accordingly, the application may include information about the donor's identity, social security number, donor's stated income, collateral identity, stated value of the collateral, and amount of the loan. Other information is typically included such as any representations by the borrower that are to be relied on in the loan process. The application may be a proprietary loan application or standardized application such as a uniform residential loan application such as the FannieMae form 1003.

In one embodiment, the charitable giving liaison organization 107 has an active role in processing the donor's application including performing credit checks, obtaining property appraisals, obtaining title documentation and underwriting, and the like. Several basic considerations of a loan underwriter are to determine the donor's ability to repay a loan, the donor's willingness to repay the loan, the donor's past history of prompt payment of financial obligations, and to evaluate any collateral used to secure the loan. In accordance with particular embodiments, the donor's strong ownership position in the collateral is required to be sufficiently high as to strongly influence the underwriting decision.

Upon completion of the loan approval activities, the charitable giving liaison organization 107 prepares documentation required by funding source 109. It is contemplated that funding source 109 may be the same business entity as charitable giving liaison organization 107. Alternatively, funding source 109 may be a separate entity such as investment bank, government agency, or other person/entity that provides funds. In some circumstances, the funding source 109 may perform all loan approval and underwriting activities, and prepare the documentation. Charitable giving liaison organization 107 assists in closing the transaction with donor 101, and provides the note or deed of trust and a property deed to funding source 109 as collateral. Funding source 109 provides funds corresponding to the amount donated to charitable organization 103. In a particular embodiment, a portion of the funds in the order of 1% or greater is provided to charitable giving liaison organization 107 as compensation for services rendered. In a particular example, the charitable organization 103 and the funding source 109 each pay a portion of the service fees to charitable giving liaison organization 107. Alternatively, donor 101 may pay this small service fee directly to charitable giving liaison organization 107. This amount is expected to be significantly less than the overhead costs associated with alternative conventional fundraising techniques. Additionally, donor 101 may pay closing and other fees similar to those charged in a mortgage transaction. Alternatively, funding source 109 may provide the funds for these closing and other fees in which case the total loan amount would include the sum of the donated amount, closing costs, and any other fees paid by funding source 109.

The donation to charitable organization 103 results in a tax deduction that is provided to donor 101. The tax deduction for the donated amount and for the closing and other fees can be taken immediately, or alternatively taken to offset income over some period of time. The small portion of the donation that is paid to charitable giving liaison organization 107 may be tax deductible as well. Significantly, donor 101 retains possession of the property, although it is pledged as collateral to funding source 109. Donor 101 may live in and enjoy the property, or in the case of commercial property continue to receive income generated by the property as well as benefits associated with increased value of the property.

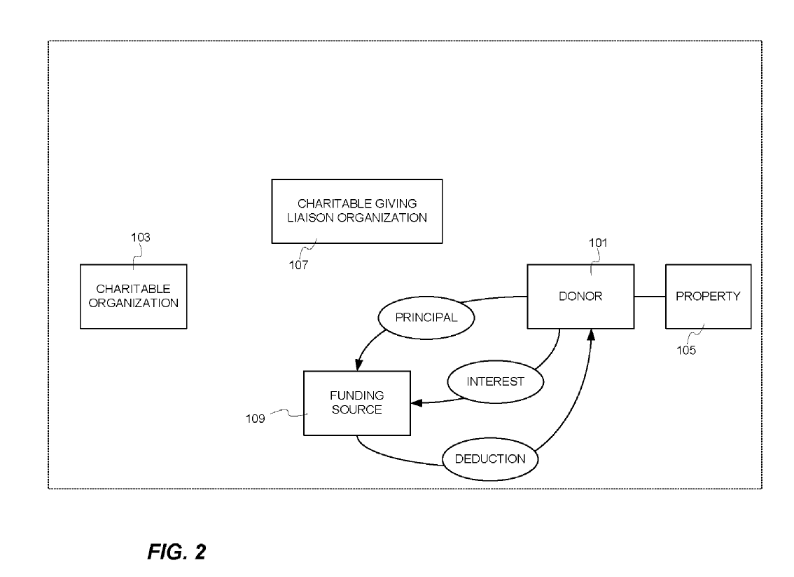

Going forward after the initial funding, the particular implementation may continue to generate tax benefits for donor 101 as shown in FIG. 2. In FIG. 2 it is important to recognize that charitable giving liaison organization 107 and charitable organization 103 may choose to operate largely if not entirely independent of the donor 101 and funding source 109. This is very attractive to charitable organization 103 because, although it benefits from the property-based donation, it does not have responsibility for maintaining and managing the property or converting that property to a form that is suitable for its charitable purpose. Risks associated with the value of the property, inflation, economic strength, and the like are allocated between funding source 109 and donor 101 leaving charitable organization 103 comparatively free of these risks.

In one embodiment, donor 101 continues to make periodic interest-only payments to funding source 109. Alternatively, donor 101 makes periodic payments that cover interest and a portion of the principal to funding source 109. These principal payments may be designed to fully repay the principal in a specified period of time, or partially repay the principal. Either payment structure may have benefits to particular donors. These payments may be made on a monthly, quarterly, annual or other basis. Donor 101 will receive corresponding tax benefits for these payments. Alternatively, the interest payments may be accrued during the life of the loan in which case the interest will add to the principal amount due to the funding source 109 when property is transferred or otherwise disposed of. Depending on the timing of the property transfer relative to the death of the donor, the donor or their estate may or may not receive tax benefits for the accrued interest. For example, when the donor's estate pays accrued interest it will be deductible against income of the estate. The interest payment will also reduce the size of the estate (as will the repayment of principal) which may in turn reduce estate taxes. However, in a situation in which the estate has less income than the accrued interest and/or estate taxes are not owed, the potential tax benefits associated with the payment of accrued interest may not be realized. In yet another alternative, the amount of the donation made to charitable organization 103 may be discounted by an amount sufficient to account for interest payments such that no interest payments are due. In this case, the donor may be able to receive tax benefits only for the amount of the discounted note.

In another alternative shown in FIG. 3, a portion of the payments made from donor 101 to funding source 109 is used to make supplemental gifts to charitable organization 103 over time. These supplemental contributions may result in additional tax deductions for donor 101. One advantage of such an implementation is that the charitable organization 103 will receive a steady stream of contributions over time which may be desirable. However, under current I.R.S regulations it is expected that these periodic contributions will not be tax deductible unless funding source 109 charges a premium (i.e., above average) interest rate, which may not be practical or possible under regulations that control interest rates. Alternatively, periodic payments by the funding source 109 to charitable organization 103 may be tax-deductible for the funding source 109.

As with conventional financial arrangements, it is contemplated that funding source 109 may sell or otherwise transfer its rights and obligations under its agreements with donor 101 and/or charitable organization 103 to anther entity. The loans made to donor 101 are, in many cases, of unusually high quality due to the nature of the individuals and entities that are interested in charitable contributions, and so individual loans and loan packages comprising multiple loans may sell at a premium as sound investment products. Several loans in accordance with the present invention may be consolidated into a loan portfolio for sale and/or securitization. Alternatively, loans in accordance with the present invention may be packaged with other conventional loans for sale as the characteristics of the loan in accordance with the present invention may balance out the portfolio risks associated with some conventional loans.

It is significant once again to recognize that donor 101 retains possession of the property, although it is pledged as collateral to funding source 109. Donor 101 may live in and enjoy the property, or in the case of commercial property continue to receive income generated by the property as well as benefits associated with increased value of the property. The donor 101 is free to disposition the property as desired at any time. Hence, donor 101 may sell, lease, and/or borrow against the property subject to the note held by funding source 109. It is contemplated that the funding source may allow the charitable giving loan in accordance with the present invention to be subordinated by subsequent loans on the donor's property. In many cases the donor's remaining interest in the property will be transferred upon the donor's death by a will, trust or by operation of law (e.g., intestacy law). Upon such transfer, funding source 109 may require that the principal amount owing be repaid. While this principal payment will not result in a tax deduction (which was taken earlier) it will reduce the amount of the estate such that estate taxes may be reduced.

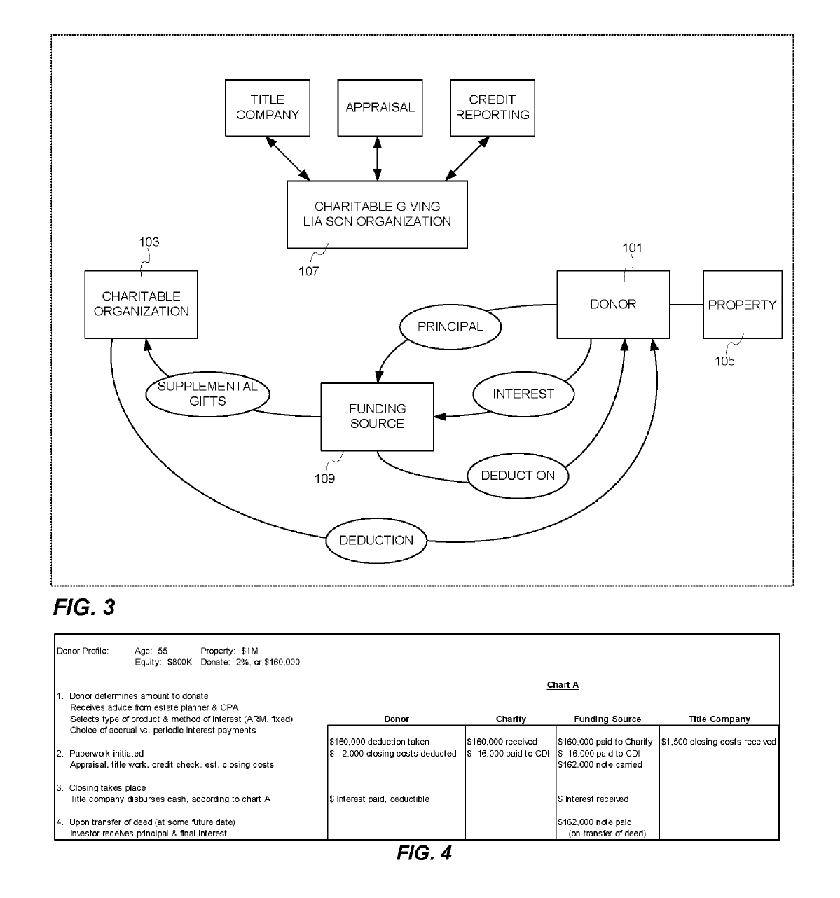

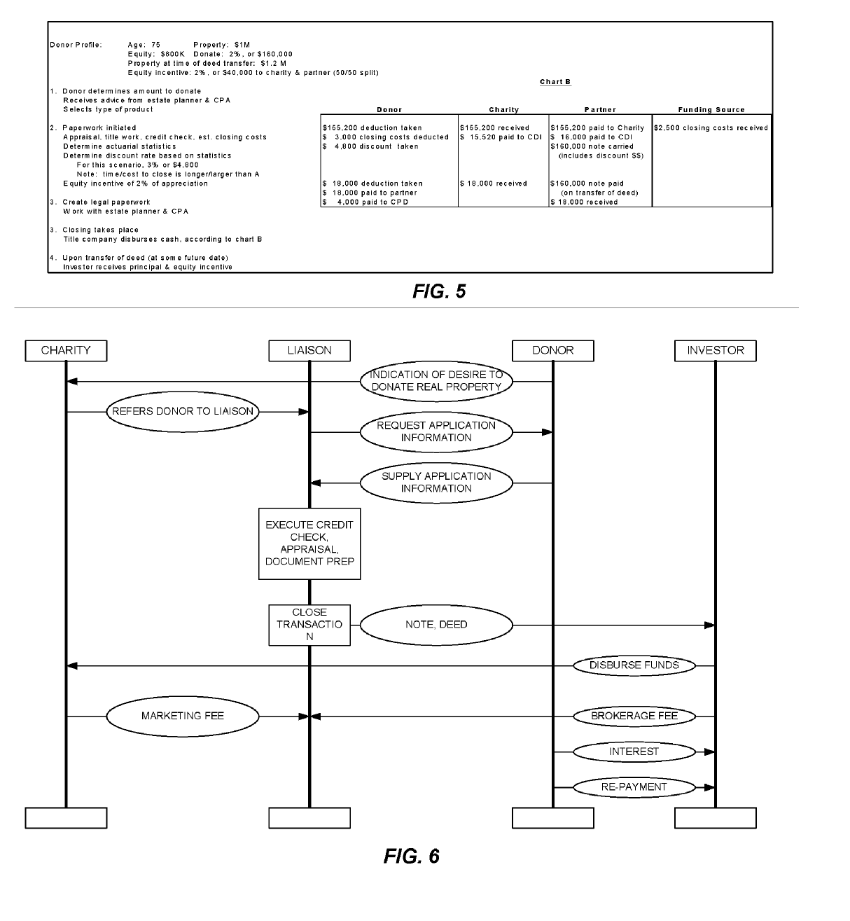

FIG. 4 illustrates a first donor profile report summarizing the operation of the present invention with respect to a 55 year old donor while FIG. 5 illustrates a second donor profile report summarizing the operation of the present invention with respect to a 75 year old donor. The financial situations and desires of relatively younger donors differ from that of more mature donors. For example, one option that exists in forming a charitable giving loan in accordance with the present invention is whether the donor will make periodic interest payments. In the case of a younger donor, it may be desirable to accrue interest rather than make periodic payments such that the accrued interest creates a tax benefit when the underlying property is sold or refinanced. Alternatively, the donor may wish to make periodic interest payments that will result in a tax deduction when made.

In the case of older donors, the likelihood is greater that the underlying property will be transferred to heirs or be liquidated after the donor's death. In such a circumstance, accrued interest will not result in a tax benefit to the donor. Hence, an older donor may prefer the original loan amount to be discounted based on actuarial analysis to reduce or eliminate periodic payments. Discounting results in a smaller immediate donation and tax deduction, however, this may be desirable for donors wishing to avoid a commitment to monthly payments. Alternatively, because the accrued interest will reduce the size of an estate and therefore may reduce estate taxes, a negatively amortized loan that accrues interest may be acceptable or preferred.

FIG. 4 and FIG. 5 illustrate the allocation of funds to various entities in the specific scenarios. The charitable organization is the primary beneficiary, with industry standard amounts being paid to the title company and funding source. The charitable giving liaison organization receives a marketing fee from the charitable organization in the order of about 1%-10% and a brokerage fee from the funding source in the order of 1%-3%, although the amount may vary significantly to meet the needs of a particular application. It is also contemplated that the marketing fee and/or brokerage fee may be a single fixed fee, a payment stream over time, or any other arrangement of payments agreed upon by the parties.

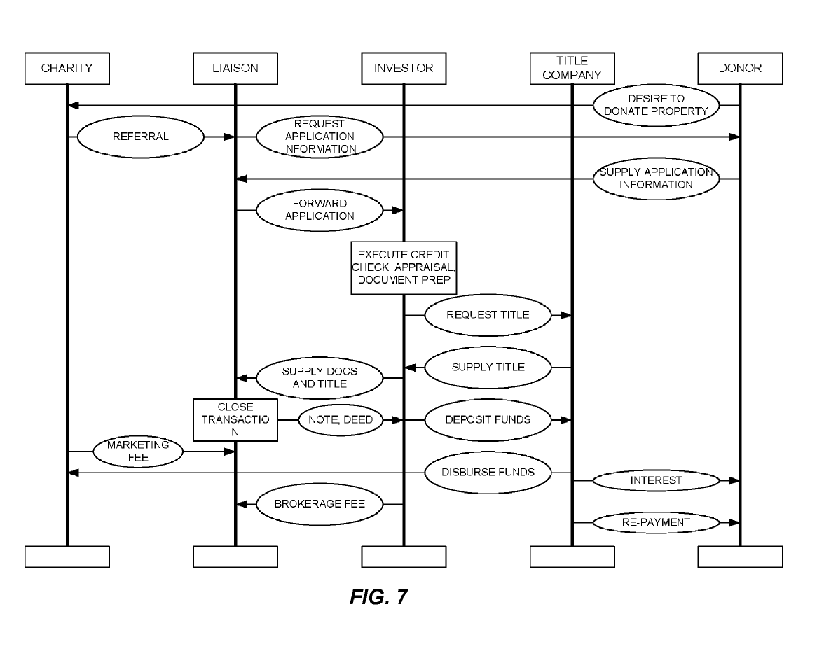

FIG. 6 shows a message sequence diagram of an embodiment of the present invention. In the embodiment of FIG. 6 the charitable giving liaison organization plays an active role in assisting the donor and funding source in the preparation of documents and various loan approval activities. The active role played in the embodiment of FIG. 6 enables the charitable giving liaison organization to provide such services as credit checks, appraisals, document preparation and the like that may be unfamiliar or impractical to be performed by the funding source directly. In contrast, FIG. 7 shows a message sequence diagram of an alternative embodiment in which the charitable giving liaison organization serves primarily as a consultant to the activities that are performed by others. In many cases the funding source is an experienced loan processing organization that will prefer to use their own loan processing mechanisms in conjunction with organizations such as a title company.

Although the present invention has been described primarily in terms of an individual donor making a donation from personally owned assets, the invention is applicable to commercial entities such as corporations, partnerships, limited liability companies, and the like that wish to make gifts to charitable organizations based on wealth held in property. As shown in FIG. 8, a corporation 801 owns property 805, which may include any variety of commercial property including industrial, manufacturing, apartments, office buildings, as well as personal property held by the business entity. In general, so long as the property is capable of serving as collateral for a loan it is suitable for use in the present invention.

Like the previous embodiments, once a donor corporation 801 indicates a desire to make a gift to a charitable organization 103, an application is prepared that includes information on the property, income, credit worthiness, and other information typically required in a commercial lending transaction. Charitable giving liaison organization 107 prepares documentation for the loan which may include executive summary, borrower credit and financial analysis, subject property income analysis, property profiles, preliminary title reports, rent roll/lease summary, financial spreadsheets, property plats, floor schematics, subject property photos, preliminary environmental reports (if needed), area maps and demographics, and any other information deemed desirable for a successful loan package. The commercial loan request is packaged and submitted to one or more funding sources 109.

One or more of the funding sources 109 may provide a letter of intent indicating the terms and conditions of the proposed loans they are willing to offer. The particular interest rates, terms, loan amounts, and the like are based upon factors including credit rating, income, debt service ratio, loan-to-value, cash savings/reserves, environmental reports, clear title, property appraisal and the like. When multiple lenders are approached the donor 801 may select amongst those that respond by signing and returning the letter of intent. A number of third party reports may be requested by either funding source 109 or charitable giving liaison organization 107 such as appraisals, environmental reports, and the like. A final loan package is resubmitted to the funding source 109 for final approval and the funding source 109 issues a final loan commitment. The loan closes at a specified closing time at which point the charitable organization 103 receives the donation and donor corporation 801 receives a tax deduction, which may be taken immediately or carried over to future years according to I.R.S. regulations.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

What is claimed is:

1. A method of charitable giving comprising:
providing a donor with an ownership interest in a property, wherein the property is suitable as collateral for a loan;
generating a loan of an amount of money from a funding source, wherein the loan is secured by the donor's ownership interest in the property;
gifting at least a portion of the proceeds from the loan to one or more charitable organizations; and
generating a tax benefit to the donor corresponding to the gifted portion of the loan.

2. The method of claim 1 wherein the act of loaning the amount of money comprises:
causing the donor to submit an application to a charitable giving liaison organization;
using the charitable giving liaison organization to document the application; and
underwriting the loan using information from the documented loan application.

3. The method of claim 2 wherein the funding source comprises one or more entities selected from the group consisting of: a charitable giving liaison organization, investment bank, commercial bank, mortgage company, investment trust, individual, and investors.

4. The method of claim 1 wherein the gifted portion of the loan is less than the amount of money loaned.

5. The method of claim 1 further comprising:
causing the donor to make periodic payments to the funding source, wherein a portion of the periodic payments is tax-deductible to the donor.

6. The method of claim 1 further comprising:
repaying principal due to the funding source upon a transfer of the property.

7. A financial product made by the method of claim 1.

8. A business system for charitable giving comprising:
a funding source;
a donor owning property;
a charitable organization; and
means for generating a loan of funds from the funding source to the charitable organization, wherein the loan is secured by a note from the donor and a security interest in the donor owned property.

9. A method for providing a charitable donation liaison service comprising:
contacting a charitable organization;
contacting donors having property assets from which they desire to make charitable gifts;
accepting an application from the donor, the application indicating information about the donor's identity, social security number, donor's stated income, collateral identity, stated value of the collateral, and amount of the loan;
documenting the donor's application; and
causing a funding source to provide an amount of liquid assets to the charitable organization resulting in a corresponding tax benefit for the donor.

10. The method of claim 9 wherein contacting donors further comprises contacting third party fund raiser, estate planning attorney, accountant and/or financial advisor.

11. A method of operating a lending entity to benefit charitable organizations, the method comprising:
accepting a loan application from a donor;
determining whether to approve the loan application;
upon approving the loan application, securing the loan using property owned by the donor; and
disbursing funds to a charitable organization, whereby the donor receives an immediate tax benefit as a result of the funds received by the charitable organization.

12. The method of claim 11 wherein the property comprises real estate.

13. The method of claim 11 wherein the donor has an equity interest in the property that exceeds fifty percent.

14. The method of claim 11 wherein the loan accrues interest until the loan is repaid.

15. The method of claim 11 wherein the loan requires periodic payment of interest until the loan is repaid.

16. The method of claim 11 wherein the amount of funds disbursed to the charitable organization is discounted from the amount of the loan by an amount selected to reduce interest due on the loan.

17. The method of claim 11 wherein the loan requires repayment upon change of ownership of the property and/or refinancing of the property.

18. A method of operating a charitable organization comprising:
receiving a request from a donor, wherein the request states a desire on the part of the donor to make a gift to the charitable organization based on wealth that is held in property owned by the donor;
causing the donor to obtain a loan for specified funds from a funding source that is secured by the property owned by the donor; and
receiving the specified funds from the funding source.

19. The method of claim 18 wherein the donor receives a tax benefit as a result of the receipt of the specified funds from the funding source.
